(19) United States
(12) Patent Application Publication
(10) Pub. No.: US 2006/0212474 A1
(43) Pub. Date: Sep. 21, 2006

(54) Specifying application content using data-driven systems

(75) Inventors: Thomas J. McCormack, Concord, MA (US); Matthew Scott Seegmiller, Somerville, MA (US); Robert J. Webster, Groveland, MA (US)

Correspondence Address: Bingham McCutchen, LLP, Suite 1800, Three Embarcadero, San Francisco, CA, 94111-4067, US

(73) Assignee: Muzzy Lane Software Incorporated, Newburyport, MA (US)

(21) Appl. No.: 11/083,760

(22) Filed: Mar. 16, 2005

(51) Int. Cl. G06F 17/00

(52) U.S. Cl. 707/103 Z

(57) ABSTRACT

Specifying content using data-driven systems is described, including creating a definition, the definition having a type and a property, instantiating the property, deriving a property value for the property using a linkage, and synchronously pushing an update to the property value over the linkage. Also described are building an object and a backing class, the object having a definition and a property for the definition, relating the backing class to the object based on the definition, and identifying a relationship between the object and another object, the object and the another object being related based on the backing class.

### FIELD OF THE INVENTION

The present invention relates generally to software. More specifically, specifying application content using data-driven systems is described.

### BACKGROUND OF THE INVENTION

Developing computer programs or applications (hereinafter “applications”) can be performed by using object-oriented programming languages such as Java, C++, and others. For the presentation of content, formatting languages such as HTML, XML, SGML and the like are also used. Object-oriented programming languages have enabled users, developers, architects, and engineers (hereafter “users”) to rapidly design and develop complex applications for a wide range of uses, including personal (e.g., entertainment, gaming, word processing, accounting, and others) and business (accounting, financial, resource management, work flow analysis, customer relationship management (i.e., CRM), sales force automation (i.e., SFA), accounting, storage, networking, communications, and others). However, developing applications using object-oriented programming and formatting languages often requires adherence to inflexible standards and conventions, reducing user efficiency and increasing development burdens.

While object-oriented programming languages are more efficient than unstructured programming languages (e.g., Fortran, C, and the like), object-oriented languages also depend upon the use of objects and object definitions that set forth the various characteristics, parameters, or properties to enable the definition and instantiation of objects. In conventional solutions, developers constantly re-write portions of source code in order to modify specific objects, object definitions, or instantiations in order to accommodate changes. Users need access to the original source code along with in-depth technical knowledge and an understanding of how the underlying system works, which may also require knowledge and experience in application development using object-oriented languages. In many cases, objects in a data system are modified at an individual level, which is both inefficient and time-consuming for even highly trained users. These individual changes may require compilation of source code for each change, which increases the amount of time required to develop and test changes to an application's source code. Further, changes made in this manner may cause undesired results that can be costly and time-consuming to remedy. Still further, conventional solutions may require skilled and experienced technical users in order to effectively implement an application, thus precluding implementation or changes to an application by users who may be subject matter experts (e.g., historical gaming, education, professional, and the like), but lack substantive technical skills and the experience required to modify source code.

Thus, what is needed is a solution for specifying content without the limitations of conventional techniques.

### BRIEF DESCRIPTION OF THE DRAWINGS

Various embodiments of the invention are disclosed in the following detailed description and the accompanying drawings:

FIG. 1A illustrates an exemplary system for specifying content;

FIG. 1B illustrates an alternative exemplary system for specifying content;

FIG. 2 illustrates an exemplary system for specifying content;

FIG. 3A illustrates an exemplary object definition file;

FIG. 3B illustrates an exemplary object instantiation file;

FIG. 4 illustrates an exemplary implementation of an system for specifying content;

FIG. 5 illustrates an exemplary logic module configured to specify content;

FIG. 6 illustrates an exemplary process for specifying content;

FIG. 7 illustrates an exemplary process for specifying an object property value;

FIG. 8 illustrates an alternative exemplary process for specifying content;

FIG. 9 illustrates another alternative exemplary process for specifying content; and

FIG. 10 is a block diagram illustrating an exemplary computer system suitable for specifying content.

### DETAILED DESCRIPTION OF THE PREFERRED EMBODIMENTS

The invention can be implemented in numerous ways, including as software, hardware (e.g., circuitry), a process, an apparatus, a system, a method, or as a set of instructions on a computer readable medium such as a computer readable storage medium or a computer network wherein program instructions are sent over optical or electronic communication links. In general, the steps of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the examples has not been described in detail to avoid unnecessarily obscuring the description.

Specifying application content (hereinafter “content”) using data-driven systems enables development of objects using classes and sub-classes to determine structure, behavior, and relationships, between objects without requiring individual changes to source code for each modification (e.g., addition, deletion, change/overwrite, and the like) to an object, object definition, object instantiation, property, property definition, or property value. Additionally, specifying content using data-driven systems extends and defines the behavior of computer applications in the form of data files or other data sources. Various types of file formats and programming languages may be used, including XML, SGML, HTML, and the like. Rapid design and development may be achieved by specifying content using sub-classes to define a variable use of a property definition for multiple objects. Object definitions may be used for various objects to enable flexible definition and instantiation of objects related by a common sub-class or property.

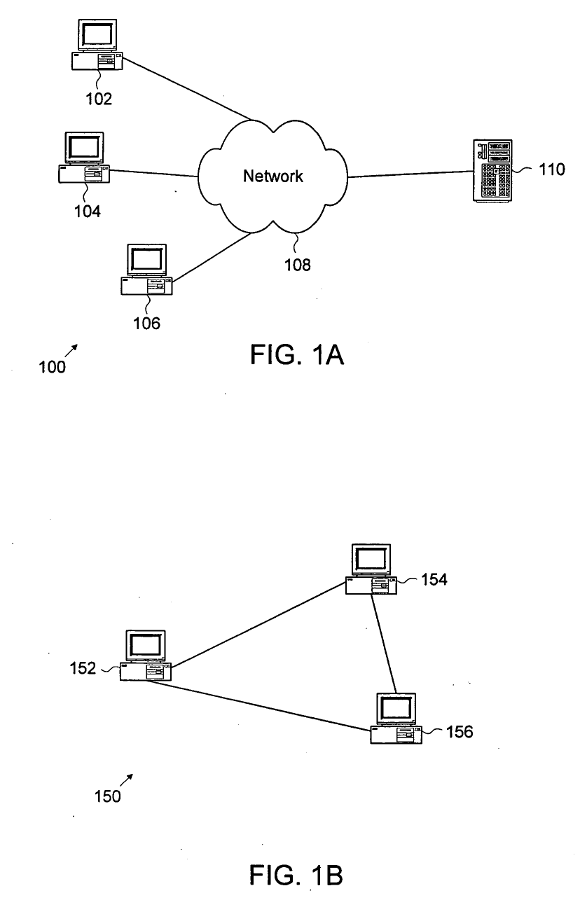

FIG. 1A illustrates an exemplary network system for specifying content. In this example, system 100 includes clients 102-106 communicating over network 108 to server 110. Clients 102-106 may communicate (e.g., bi-directional data exchange) with server 110 using any form of data communication protocol. System 100 may also be an implementation environment for server-side and client-side applications using techniques such as those described below. Here, network 108 may be implemented using a local area network (LAN), wide area network (WAN), wireless local area network (WLAN), municipal area network (MAN), the Internet, or the like. Other networks may be used in addition to those specified above. Links between clients 102-106, network 108, and server 110 may be implemented using a single connection or multiple connections (i.e., hops) between various types of networking components, including other servers, routers, hubs, exchanges, switches, and the like.

FIG. 1B illustrates an alternative exemplary network system for specifying content. Here, system 150 includes clients 152-156. Any of clients 152-156 may be used as a “server” or central host for a server-side application to specify content. For example, clients 152 and 156 may be communicating with client 154, which has been configured by a network administrator to act as a server. In some examples, client 154 may be locally connected to clients 152 and 156. In other examples, client 154 may be remotely connected to clients 152 and 156 across a distributed network such as the Internet. Alternatively, clients 152 and 156 may be part of a network (e.g., LAN) and client 154 may be implemented as part of another network (e.g., another LAN), but communication between the networks occurs (e.g., over the Internet). In still another example, clients 152-156 may be participating in a virtual private network (VPN), established across other public or private networks. Other types of network configurations may be used for purposes of implementing a system for specifying content.

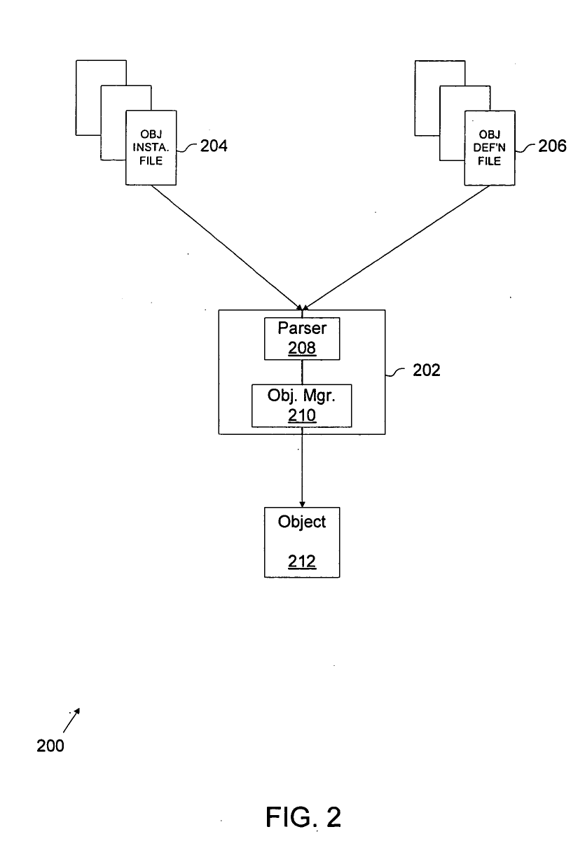

FIG. 2 illustrates an exemplary system for specifying content. Here, system 200 may be used to create a data object system. System 200 includes core system module 202, which draws on object instantiation files 204 and object definition files 206, which are interpreted by parser 208 and translated into a series of requests for creating an object. Object definitions and instantiations may be stored in a database using various types of data storage formats (e.g., relational (e.g., SQL), hierarchical, flat file, object, and others). In some examples, parser 208 may be implemented to read and interpret files in various formats (e.g., binary, plain text, comma separated value, XML, SGML, HTML, and the like). In other examples, parsers may be implemented to read data stored in other file formats such as, .ini (a text-based file format used to specify system parameters in older forms of Windows® developed by Microsoft Corporation of Redmond, Wash.), Excel (e.g., a spreadsheet application also developed by Microsoft), Access (a database product also developed by Microsoft), and others. In still other examples, multiple parsers may be implemented, which permits data to be read and written in numerous file formats. For example, files read in XML may also be written by other parsers in a database format (e.g., relational (e.g., SQL), hierarchical, flat file, object, and others). A series of requests are sent to object manager 210 to create object 212. In some examples, object manager 210 may be an application (e.g., written in a compiled language such as C++, or an interpreted language such as Python), which handles requests from parser 208 and creates objects, properties, listeners, or property linkages (i.e., “linkages”) in an object data system. Different components may also be included in system 200. Object 212 may be either a base object or a derived object. A base object has properties defined in a formatting language (e.g., XML) that refer to a backing class. A backing class may be written in any object-oriented language, whether the language is compiled similar to C++ or interpreted similar to Python. A backing class includes processing code for object 212. Object 212 may also be defined by inheritance. In some examples, inheritance refers to a new object inheriting properties and functionality of a parent object. If inheritance is used during the creation or definition of object 212, additional properties and functionality may also be added. In other examples, the properties and functionality of an object may also be “derived” by specifying a different backing class.

In some examples, system 200 may be used to define a new type of object that “inherits” the properties and functionality of a parent. Object 212 may be output in various data formats (e.g., binary (e.g., a compiled version of the object in binary while an application is running or a binary file including data for either object instantiation or definition), XML, SGML, HTML, and the like). System 200 provides a framework that allows for the creation and manipulation of objects (e.g., content) in a data system such as system 200. As a framework, several constructs are used to provide for content specification, including objects, object definitions, object instantiations, each of which may have properties and property values. Additionally, data elements may also be used. For example, an XML, SGML, or HTML-formatted document generated from server 110 (FIG. 1) may be sent from server 110 across network 108 to client 102, which draws upon libraries to define, instantiate, and render objects specified by the document as content on a user interface (UI) at client 102.

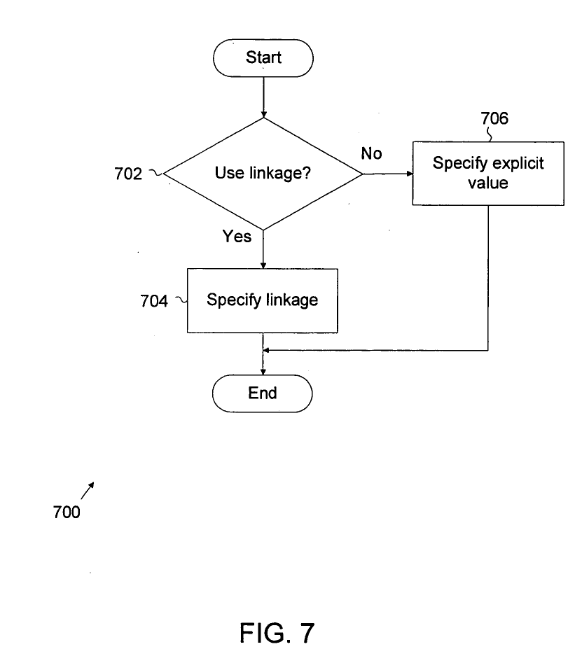

As used herein, an object may be an entity that contains properties. An object may also be described by an object type. An object may also be specified based on one or more properties within an object specification. Each property has a property value that may be either an explicit value (e.g., number, character) or a function that points to a location of where a value may be derived. Values may be derived over a linkage that provides a value for an associated property. A linkage may be implemented to define a method or technique for deriving a property value based upon the values of other properties and objects in the system or how to create a new object or set of objects by combining the properties of existing objects in system 200. Linkages may be used based on the type of programming or formatting language in use, such as XML, HTML, SGML, and the like. A derived property value using a property linkage may be either explicit or derived from a linkage specifying an expression, function, computation, or the like, as described in greater detail below in connection with FIG. 7.

As an example, object types may be used to specify an object. Object types such as “Functions,” “Selection,” or “Commands” may be used to specify a purpose for an object. “Functions,” in some examples, are similar to “computeFrom” functions (described in greater detail below), specifying an expression that may be used to compute a property value as a type of property linkage. Unlike computeFrom functions, Functions are not specified when a property is instantiated, but instead are included in the specification of another object. This allows Functions to push the output of a specified function as a value for one or more properties. Subsequently, a cascading effect occurs where an object, when instantiated, synchronously pushes updates to other objects, properties, and property values. As an example, the updates are synchronized to occur for the object and related (i.e., embedded objects referenced by Functions) when instantiation occurs. In other examples, changes occur synchronously when notifications of changes are sent to system 200. Listeners are inherent constructs of object types that, when a property change occurs, notify related or embedded objects of the property change, causing a cascading effect throughout system 200. The cascading effects caused by listeners may be used to implement property linkages. In some examples, listeners may monitor one or more properties and are notified when changes to the monitored properties occur. The cascading effect performed by listeners thus implements changes for objects, properties, and property values without requiring manual modification or extensive code review by users, system administrators, or developers (hereinafter “users”).

Another object type is Selection. Selection object types filter a variable storage property of an object based on one or more criteria. In some examples, objects are filtered based on certain user or machine-specified criteria, causing objects that pass through the filter to be output to another variable storage property providing another type of property linkage. In other words, objects are selected based on the criteria. However, if the criteria change, Selection object types may be notified and objects in a variable storage property are re-filtered based on the new criteria. If objects that previously passed through the filter do not pass based on the new criteria, these objects are removed from the variable storage property.

Yet another object type is Command. In some examples, Commands enable a user to manipulate system 200 using a generic facade. In other words, a generic action performed by a user may be used to specify or create objects using the framework of system 200. Commands may be implemented as part of a user interface such that when a user performs a function (e.g., mouse click, scrolls over an icon, moves a pointer to a particular part of a web page, and the like), a Command is run. In some examples, while a command is running, other commands may be triggered to run. Other commands that are triggered to run by the running command are also run before the command is finished.

In other examples, a set of commands may be specified. These commands may be run sequentially, based on how the commands are related to a specification (e.g., object definition file, object instantiation file). This set of commands may be specified in a file or other object instantiation and referenced from a command line, from another command, or from another command source.

In some examples, an object is defined by an object definition in which one or more property definitions are provided for each property in the object. Objects may also be categorized by type and an object definition may also specify property definitions for each property in each object of a particular type. Each property may include one or more property values. A property that is configured to store a single property value may be referred to as a “single storage” property. If the property is configured to store more than one property value, then the property may be referred to as “variable storage.” In turn, properties may be primitive types such as “int,” “float,” “string,” and the like. In some examples, properties may also contain other objects (“embedded objects”) or have a specified relationship with other objects. Embedded objects provide for containment as well as inheritance (i.e., specification of other objects that act as inheriting values from other objects) in system 200.

In other examples, core system module 202 may automatically generate object 212. In other examples, tools, utilities, or applications (hereinafter “applications”) may be used to manually specify content (i.e., objects). Specifying content may also refer to specification of objects, object definitions, object definition files, object instantiation files, object properties, object property values, and any other entities for specifying content as described below.

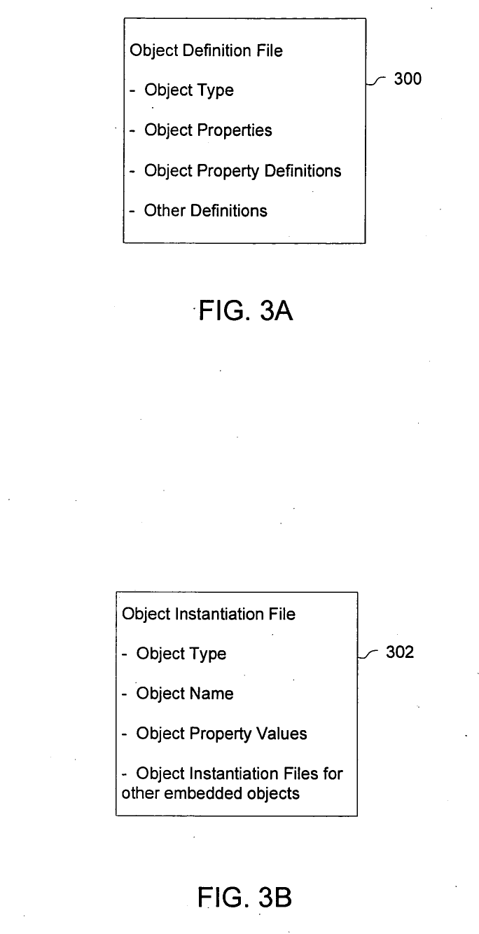

In some examples, an object and its associated properties are specified in an object definition. Object definitions are described in greater detail below in connection with FIG. 3A. Object definitions may be specified in the form of XML, SGML, or HTML documents, plain or comma separated text files, SQL databases or data stored in some other file format and include a “type” element. In some examples, an object definition may also include another element that specifies another object type with other properties that should be included within the specification of the object. In still other examples, the name of a backing class may be specified. Also, data elements may be used by system 200 to create and specify objects, object properties, and object property values.

Data elements, in some examples, may be used by system 200 to define and instantiate objects. Some examples of data elements include “objectDef,” (which is described in greater detail below), “propertyDef,” “object” (which is also described in greater detail below), and “property.” A naming convention may be used where the data element name begins with a lower case letter, but may include other letters and numerals. These data elements may be used to specify object definitions and instantiations, which are described in greater detail below in connection with FIGS. 3A and 3B.

Referring back to FIG. 2, “propertyDef” describes the definition of an object property. Some of the elements that may be included with this element are “name,” “type,” “subtype,” “number,” and “default,” all of which are described in greater detail below. In other examples, the “property” element may be used to describe the instantiation of a property. Some of the elements that may be included with this element are “name,” “value,” “inheritFrom,” and “computeFrom.” The elements of “name,” “value,” and “inheritFrom” are described in greater detail below in connection with FIG. 3B. In some examples, “computeFrom” is an expression that computes the value of a property. If properties in the expression change, then the value of the property is updated to accommodate the changes. Other properties, property values, and elements used by a framework such as system 200 for specifying content are described below.

FIG. 3A illustrates an exemplary object definition file. In this example, object definition file 300 is a potential implementation of object definition file 206 (FIG. 2). Object definition file 300 provides definitions of object types, properties associated with objects, and data that may be stored for each property. A system may also be an object-oriented application using a format for flexibly defining content in an application. Here, system 200 uses object definition file 300 as an input for specifying the types of objects that are available for object manager 210 to use when creating object 212.

Regardless of data format, object definition file 300 provides information for specifying a particular object. For example, object type, object properties, object property definitions, and other definitions (e.g., other objects that may be referred to or related to the object) are examples of information that may be included in object definition file 300. Within object definition file 300 is a data element “objectDefs,” which specifies a template for processing object definition file 300. If object definition file 300 is specified in XML, the “objectDefs” element may identify “/system/xml/objects.xsd” as a file containing an XML schema used to parse the object definitions contained in the file. Each objectDef element may include one or more sub-elements, including “type,” “super type,” “class,” and “root.”

In some examples, “type” may follow various types of naming conventions for assigning a name to a data element (e.g., objectDef). In other examples, another type of objectDef element that may be used is “superType,” which specifies a parent object from which other properties and functionality may be inherited. If a class is not specified for a type of object, then the class specified by the superType element may be inherited. Another type of specification in an object definition is “class,” which specifies a backing class that includes processing code for creating the object (e.g., object 212). For example, a user may select a class by providing a tag “CObject,” which refers to a backing class that provides basic object creation, property support, and object lifetime management information for a given object. If other properties or functionality are desired, then a new backing class may be created and also added to the object definition This backing class may be written in C++, Python or any other object-oriented language. Once specified, an object may be created by using an object factory.

In some examples, an object factory (hereinafter “factory”) is a data entity that may be used to create objects of a specified type or types. Using a factory enables developers to isolate the program code for creating an object from the overall program code of a data system. Such techniques may also be referred to as code independence. In some examples, when a data system (e.g., an XML system) creates an object (e.g., ‘CCountry’, which may be a specific object to identify a country in a game, CRM application, sales data application, and others), core system module 202 (FIG. 2) determines the appropriate factory to create the object and sends a request for the object to be created. In some examples, data system 200 does not have logic or program code for determining how the object is created, what language the object was written in (e.g., C++, Python), or a particular memory location for the object. Instead, data system 200 uses a factory to perform these functions.

In terms of objects, object definitions, and property definitions, another data element is a “class” element, which provides characteristic information that determines how a particular object should be created. Yet another data element is “root,” which may be used to indicate a root object. A root object is an object that may be referenced globally by other objects. Also included in object definition files are property definitions.

In some examples, property definitions include data elements that have sub-elements such as name, type, sub-type, number, and default values (i.e., property values). Preferably, name and type are included in an object definition. A “name” element specifies the name of a property. Names are related and are unique to an object definition. Starting with a lowercase letter, names may also include other letters and numbers. Other variations may be used and are not restricted to those described above.

“Type” is another element that specifies the type of information stored in a property of an object. For example, “object” may be specified as the type for a particular property, indicating that an object may be stored in the property. A “sub type” element may act as a further restriction on the type of information stored in the property. For example, a sub type may further specify a particular type of object that may be stored in a property. “Number” specifies the storage capacity of a property (i.e., the number of objects that can be stored in a property). “Default” specifies a default value for a property with single storage. Other property definitions may be used and are not limited to those described above.

FIG. 3B illustrates an exemplary object instantiation file. Here, object instantiation file 302 may also be used as an input to system 200 to create objects. In some examples, instantiation file 302 may be used to instantiate objects whose definitions are provided in object definition file 300. Included within object instantiation file 302 are elements such as object type, object name, object property values, and object instantiation files for other embedded objects that may be related to an object. Object instantiation file 302 may also include values for properties within an object, which override any default values when the object is instantiated. Values may include characteristics, explicit values, pointers to other files or objects, parameters, ranges, or other data that may be used to create, define, instantiate, or modify an object. Other properties may also be specified in addition to those described above.

In some examples, “tiedTos” are property linkages that may be specified in object instantiation file 302. A tiedTo may be a function that specifies other objects that are instantiated when a particular object is instantiated. In other words, a tiedTo indicates an object is related to or references another object or property. In some examples, a tiedTo may be used by system 200 (FIG. 2) to specify that for each object stored in a variable storage property, an object of a given type with the given property values is created. Additionally, if the object or property referenced by the tiedTo is deleted, then related objects that are tiedTo the object or property will also be deleted. Likewise, if the object or property referenced by the tiedTo is modified, then related objects that are tiedTo the object or property will also be modified. Modifications or deletions create cascading changes throughout system 200 without having to manually modify program code.

When used, a tiedTo function ensures that property paths within the object refer to a specific object instantiation. In some examples, a property path is a reference to another property defined elsewhere in a system (e.g., system 200, FIG. 2). As another example, “Type” is an element that may be used to specify that an object instantiation is linked to an object definition (e.g., specified in object definition file 300). This element ensures that an object is of the desired type and has the appropriate properties. “Name” is another element that may be used when an object is part of another object, either intrinsically as part of a default instantiation in an object definition or as an embedded object within another object instantiation. In some examples, if neither of the above criteria are met, the “name” element is ignored for an object.

Another type of element that may be specified in object instantiation file 302 is “From File,” which is a function that specifies a file that provides a source of objects for a property. In some examples, these files may be loaded as instantiation files, filtering out objects of the same type as the given type of instantiation, and places the remaining files in the property named by the current object. In addition to properties, property instantiations may be specified in object instantiation file 302.

Property instantiations specify values for properties in an object. In some examples, property instantiations may be specified within the default instantiation section of an object definition or within an object instantiation. In either example, each property instantiation gives either the value for a property or a source from which the property inherits a value. In some examples, single storage properties may either use an explicitly specified value or inherit a value from a property instantiation. For properties with variable storage, a new property may be added to a list for each instantiation. Property instantiations may include “name,” “value,” “Inherit From,” and others.

A “name” element may also be used to specify the name of a property for a particular property instantiation. A “value” element provides a value of a property. “InheritFrom” is a property linkage that specifies a property path from which to inherit a value for a particular property. “ComputeFrom” is another type of property linkage that provides an expression that computes a property value from a set of literals and references to other properties. Other property instantiations for object instantiation file 302 may be used other than those described above.

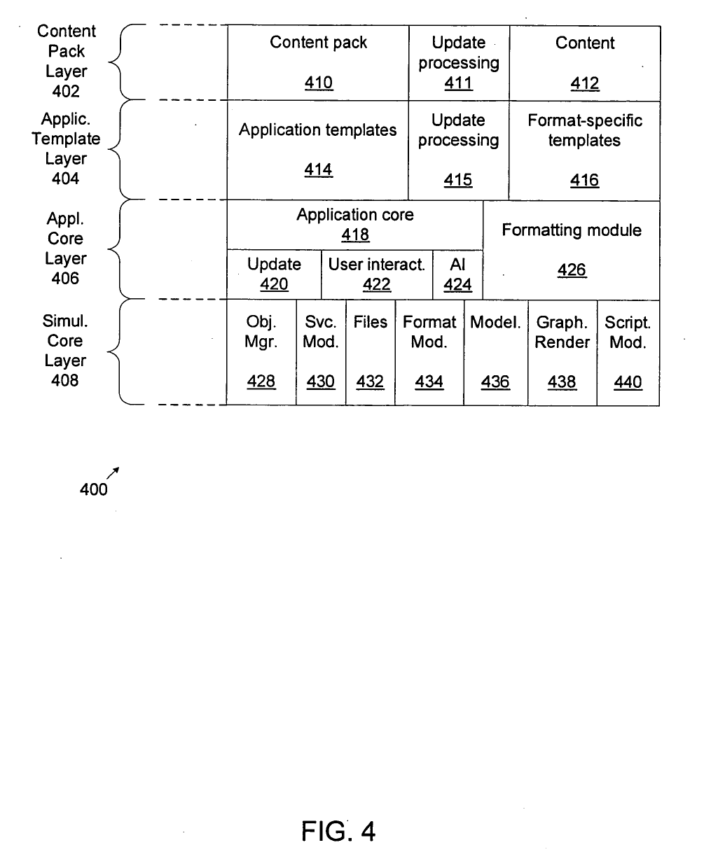

FIG. 4 illustrates an exemplary implementation of an system for specifying content. System 200 (FIG. 2) may be implemented in various types of implementation environments using a framework such as application 400. Here, a layered, block architectural schema for an application is described, which may be used as, for example, a gaming application. However, application 400 may be used for other types of implementations and are not limited to gaming examples.

In some examples, application 400 includes several architectural layers, including content pack layer 402, application template layer 404, application core layer 406, and simulation core layer 408. Within content pack layer 402 are content pack 410, update processing module 411, and content module 412. Application templates 414, update processing module 415, and format-specific templates 416 are included in application template layer 404. Here, format refers to the method used to store object definitions and instantiations (e.g., XML, SGML, or HTML documents, plain or comma separated text files, SQL databases, and the like). At application core layer 406, application core 418, update module 420, user interaction module 422, AI/logic module 424, and formatting module 426 are provided. Also in this example, simulation core layer 408 includes simulation core module 428, service modules 430, simulation files 432, format module 434, modeling module 436, and graphics rendering engine 438. Another component in simulation core layer is scripting module 440 (e.g., Python, TCL, Perl, Ruby, or Lua), which is used for interpreting and executing scripts.

Content pack layer 402 includes content pack 410 and content module 412, which may be used to provide a specific type of content for application template layer 404. For example, some application templates may support content packs for history-based strategy and analysis games, while other application templates may support content packs for first-person gaming (e.g., first-person shooter). Still other content packs may be used to change the context of the game (e.g., fantasy-fiction vs. historical role playing), while others may be used to provide specific functionality to a game.

Application template layer 404, including application templates 414 and format-specific templates 416 enable the presentation of content from content pack layer 402. Application templates 414 and format-specific templates 416 are provided to create the appropriate content environment, ensuring that content is entered and generated in an appropriate format, depending upon the type of data storage used (e.g., XML, SGML, or HTML documents, plain or comma separated text files, SQL databases and the like). Modules having multiple templates may be implemented at application template layer 404 for each of application templates 414 and format-specific templates 416. Templates may be used to create documents using content from content pack layer 402.

In some examples, application core layer 406 provides rules, parameters, logic and processing framework for application 400. Here, application core module 418 uses data from update module 420, user interaction module 422, and AI/logic module 424. AI/logic module 424 provides logic for creating documents for use by application 400. Update module 420 provides a framework to execute component modules (e.g., update processing module 411, update processing module 415) specified in content pack layer 402 and application template layer 404 that control how content is handled for operations such as creating documents, rendering content, modeling, and the like. The update driver and registration system for update processing module 411 and update processing module 415 is update module 420. Formatting module 426 works with AI/logic module 224 to generate objects for use in specifying content by application 400.

For simulation purposes when the application is in run-time, simulation core layer 408 performs various functions to support application core layer 406. In this example, simulation core layer 408 includes object manager 428, service modules 430, simulation files 432, format module 434, modeling 436, graphics rendering module 438, and scripting module 440. Object manager 428 performs various functions similar to those described above for core system module 202 (FIG. 2). Components in simulation core layer 408 enable application 400 to simulate, for example, a particular game environment, specifying content using objects generated by application 400. Graphics rendering engine 438 renders content for viewing at a user interface or other programmable interface for application 400. Other variations, modules, and components may be used in similar or different functions. Application 400 is also not limited to those components shown or the described functions and implementation environments.

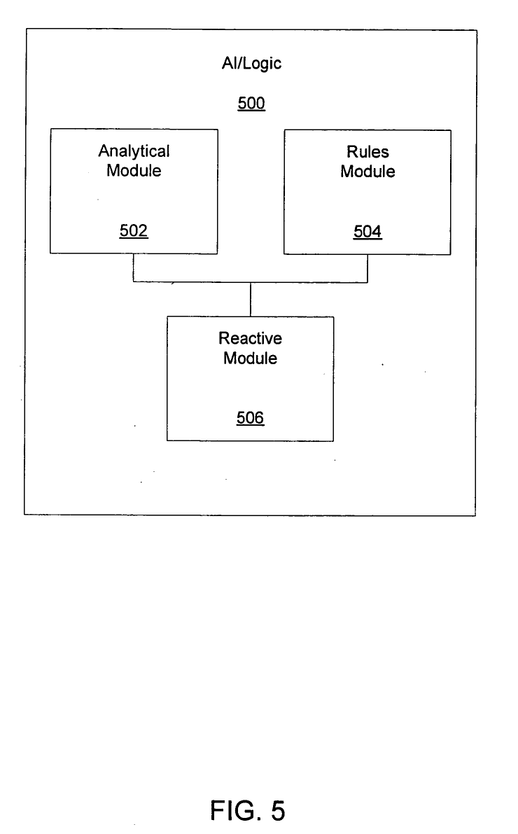

FIG. 5 illustrates an exemplary logic module configured to specify content. AI/logic module 500 includes analytical module 502, rules module 504, and reactive module 506. In some examples, AI/logic module 500 may be similar to AI/logic module 424 shown in FIG. 4. Here, AI/logic module 500 provides logic for specifying content. For example, logic provided by AI/logic module 500 may determine what types and how particular content should be presented in an application or at an application interface. In other examples, AI/logic module 500 may provide reactive logic to determine how a change to an object specification or definition should be cascaded throughout an application so as to affect other related objects. In still other objects, AI/logic module 500 may provide user-specified or automatically-generated rules that determine how objects should be created and handled by an application.

As an example, analytical module 502 analyzes data related to the specification of objects and determines how an object is affected. Rules from rules module 504 provide parameters, criteria, or explicit values that determine how an object's properties or property values should be altered. Further, reactive module 506 provides logic that determines how, if at all, other objects, if related to a changed object, should also be modified or deleted in order to reflect changes made to an object. AI/logic module 500 also provides the logic for an system and how content is handled.

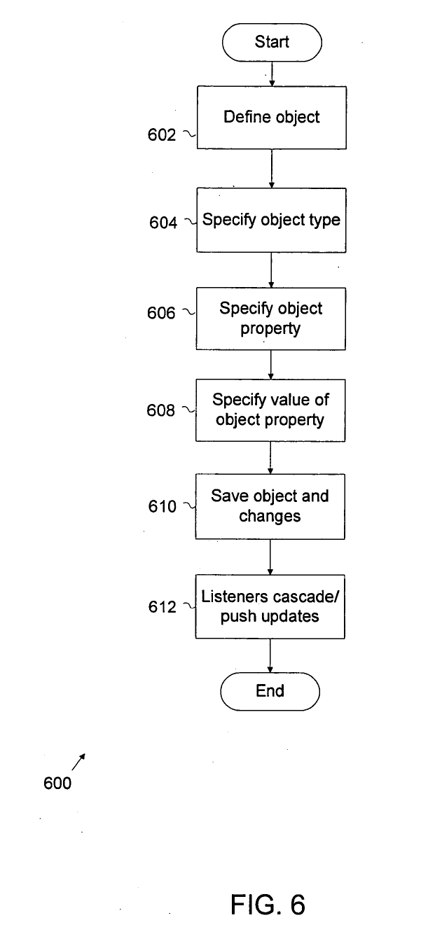

FIG. 6 illustrates an exemplary process for specifying content. In this example, process 600 initially defines an object (602). Once defined, an object type is specified (604). After specifying the object type, a property for the object is specified (606). Once a property has been specified for an object, a value is specified for the object property (608). Once the object property value has been determined, the object, object properties, and associated object property values are recorded (610). Once recorded, specialized applications called “listeners” synchronously push updates to other related objects (often indicated by the new or modified objects) and associated properties through property linkages (612).

FIG. 7 illustrates an exemplary process for specifying an object property value. As an example, process 700 provides a method for specifying an object property value. Here, a determination is made as to whether a property linkage is used (702). Property linkages are functions that may be used to derive a property value from another object, instead of specifying an explicit value. For example, inheritFrom ensures the property value being specified matches the property value of another known/related property. Another example is computeFrom, which provides an expression that computes a property value from a set of literals and references to other properties. In other examples, other property linkages may be specified and are not limited to those described herein.

If a property linkage is used, then the linkage is specified (704). If a property linkage is not used, then an explicit value is specified for the property (706). The explicit value may be a primitive type (e.g. int, float, bool, etc.), a complex type (e.g. expression, reference to another property, etc.), or an instantiation of an object to be stored in the property. Regardless, the type of explicit value matches the type of the property as specified in the property definition. Once a linkage or explicit value has been specified for the property, the process ends.

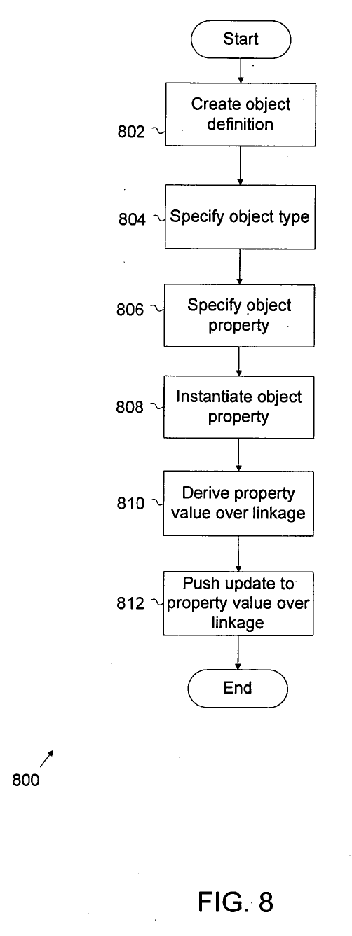

FIG. 8 illustrates an alternative exemplary process for specifying content. In this example, an alternative process is shown for creating objects in an system, such as system 200 (FIG. 2). Here, an object definition is created (802). Once created, various types of information are included with the object. For example, an object type is specified (804), an object property is specified (806), and then the object property is instantiated (808). Once instantiated, an object property value is determined for the object property over a linkage (810). In other words, a value is determined for the object property using information received over a linkage, such as those described above. Once the property value is derived, then an update to the property value is pushed by listeners over the linkage (812). The synchronous updating of the property value updates the property value for the object, but also for other objects that are related or embedded in the object that derived its property value over the linkage.

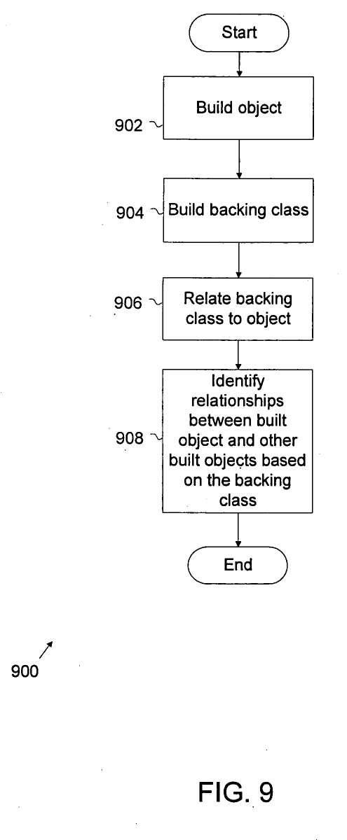

FIG. 9 illustrates another alternative exemplary process for specifying content. Here, system 200 (FIG. 2) builds an object (902). Once the object is built, a backing class is built (904). The class element of an object definition specifies what object factory is used to create the object, as described above. A class links the object to and builds a specific sub-class of CMLObject. After building the backing class, a relationship is specified with the object (906). Subsequently, relationships are identified between the object and other objects based on the backing class (908). Other objects that share the same backing class are related, providing a system for updating related objects when an addition, modification, or deletion occurs that affects an object related to other objects. Additions, modifications, or deletions may occur in an object specification, definition, property, or property value. Other embodiments of this process may be used and are not limited to those described above.

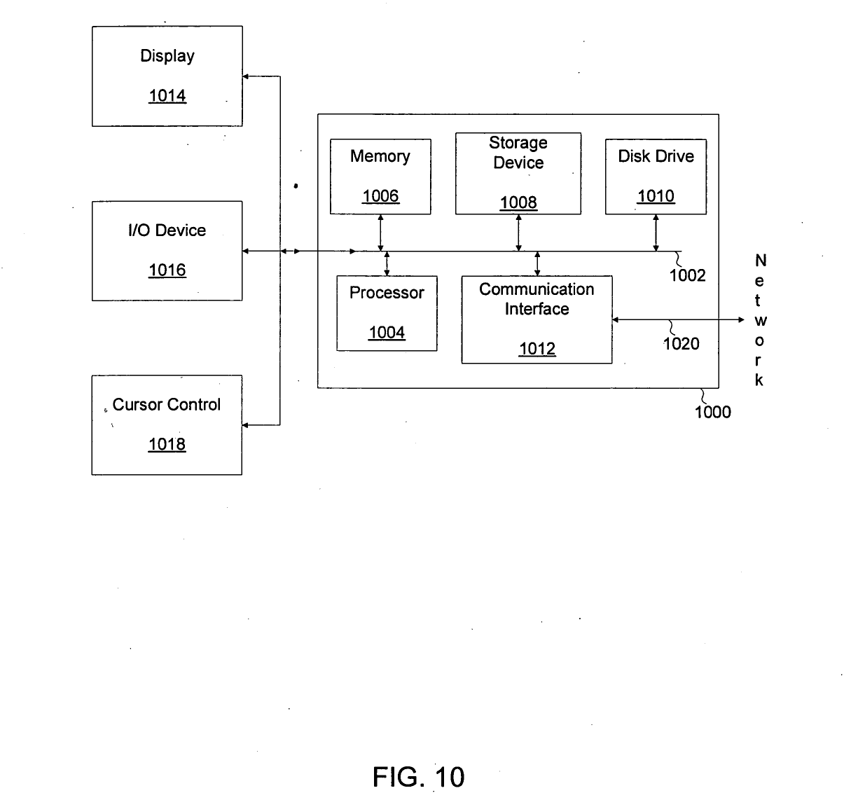

FIG. 10 is a block diagram illustrating an exemplary computer system suitable for specifying content. In some embodiments, computer system 1000 may be used to implement the above-described techniques. Computer system 1000 includes a bus 1002 or other communication mechanism for communicating information, which interconnects subsystems and devices, such as processor 1004, system memory 1006 (e.g., RAM), storage device 1008 (e.g., ROM), disk drive 1010 (e.g., magnetic or optical), communication interface 1012 (e.g., modem or Ethernet card), display 1014 (e.g., CRT or LCD), input device 1016 (e.g., keyboard), and cursor control 1018 (e.g., mouse or trackball).

According to some embodiments of the invention, computer system 1000 performs specific operations by processor 1004 executing one or more sequences of one or more instructions stored in system memory 1006. Such instructions may be read into system memory 1006 from another computer readable medium, such as static storage device 1008 or disk drive 1010. In some embodiments, hard-wired circuitry may be used in place of or in combination with software instructions to implement the invention.

The term “computer readable medium” refers to any medium that participates in providing instructions to processor 1004 for execution. Such a medium may take many forms, including but not limited to, non-volatile media, volatile media, and transmission media. Non-volatile media includes, for example, optical or magnetic disks, such as disk drive 1010. Volatile media includes dynamic memory, such as system memory 1006. Transmission media includes coaxial cables, copper wire, and fiber optics, including wires that comprise bus 1002. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some embodiments of the invention, execution of the sequences of instructions to practice the invention is performed by a single computer system 1000. According to some embodiments of the invention, two or more computer systems 1000 coupled by communication link 1020 (e.g., LAN, PSTN, or wireless network) may perform the sequence of instructions to practice the invention in coordination with one another. Computer system 1000 may transmit and receive messages, data, and instructions, including program, i.e., application code, through communication link 1020 and communication interface 1012. Received program code may be executed by processor 1004 as it is received, and/or stored in disk drive 1010, or other non-volatile storage for later execution.

Although the foregoing embodiments have been described in some detail for purposes of clarity of understanding, the invention is not limited to the details provided. There are many alternative ways of implementing the invention. The disclosed embodiments are illustrative and not restrictive.

What is claimed:

1. A method for specifying a class of objects, comprising:
creating a definition, the definition having a type and a property;
instantiating the property;
deriving a property value for the property using a linkage; and
synchronously pushing an update to the property value over the linkage.

2. The method recited in claim 1, further comprising defining a backing class.

3. The method recited in claim 1, further comprising defining a backing class, wherein the backing class relates an object to another object based on the definition.

4. The method recited in claim 1, wherein the linkage is specified using a data storage format.

5. The method recited in claim 1, wherein the linkage is a property linkage.

6. The method recited in claim 1, wherein the property value affects another property value.

7. The method recited in claim 1, wherein synchronously pushing an update to the property value uses a plurality of property values.

8. The method recited in claim 1, wherein the plurality of property values are stored in a queue.

9. The method recited in claim 1, wherein the update is another property value configured to overwrite the property value.

10. The method recited in claim 1, wherein the update is another property value to change the property value.

11. The method recited in claim 1, wherein the update provides another property value to overwrite the property value and cascade a change to the property value throughout the class of objects.

12. The method recited in claim 1, wherein the update indicates a sub-type.

13. The method recited in claim 11, wherein the sub-type references a new property.

14. The method recited in claim 11, wherein the sub-type indicates another linkage.

15. The method recited in claim 1, wherein the property value includes an explicit value.

16. The method recited in claim 1, wherein the property value is dynamically calculated using data from another class of objects.

17. The method recited in claim 1, wherein the property is a string class.

18. The method recited in claim 1, wherein the property is an object.

19. The method recited in claim 1, wherein the property is a set of objects.

20. The method recited in claim 1, wherein the property is a primitive.

21. The method recited in claim 1, wherein the property indicates another object.

22. The method recited in claim 1, wherein the property indicates another property.

23. The method recited in claim 1, wherein the property includes a property type.

24. The method recited in claim 1, wherein the property includes an object type.

25. The method recited in claim 1, wherein the linkage is configured to provide a listener to push updates to the property value.

26. A method for specifying an object, comprising:
building an object and a backing class, the object having a definition and a property for the definition;
relating the backing class to the object based on the definition; and
identifying a relationship between the object and another object, the object and the another object being related based on the backing class.

27. A system for specifying a class of objects, comprising:
a memory configured to store data; and
logic configured to create a definition, the definition having a type and a property, instantiate the property, derive a property value for the property using a linkage, and synchronously push an update to the property value over the linkage.

28. A system for specifying an object, comprising:
a memory configured to store data;
logic configured to build an object and a backing class, relate the backing class to the object, and identify a relationship between the object and another object, the object and the another object being related based on the backing class.

29. A computer program product for specifying a class of objects, the computer program product being embodied in a computer readable medium and comprising computer instructions for:
creating a definition, the definition having a type and a property;
instantiating the property;
deriving a property value for the property using a linkage; and
synchronously pushing an update to the property value over the linkage.

30. A computer program product for specifying an object, the computer program product being embodied in a computer readable medium and comprising computer instructions for:
building an object and a backing class;
relating the backing class to the object; and
identifying a relationship between the object and another object, the object and the another object being related based on the backing class.
